(19) United States
(12) Patent Application Publication
(10) Pub. No.: US 2009/0272722 A1
(43) Pub. Date: Nov. 5, 2009

(54) Method and device for cleaning the circumferential outer surface of welded metal pipes

(76) Inventors: Maurizio Sbetti, Levico Terme (IT); Gianni Vettorazzi, Levico Terme (IT)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/151,137

(22) Filed: May 2, 2008

(51) Int. Cl. B23K 26/00; G01N 21/00; B23K 31/00

(52) U.S. Cl. 219/121.6; 356/72; 228/155

(57) ABSTRACT

A method of cleaning the circumferential outer surface of a welded metal pipe focuses a laser beam above the level of the surface and melts, evaporates and/or sublimates extraneous materials and flaws present on the surface of the pipe.

### BACKGROUND OF THE INVENTION

The present invention relates to a method for cleaning the outer surface of welded metal pipes, thereby allowing the position of the welding bead of said tubes to be optically detected.

The invention further relates to a device for carrying out this method.

As is known, a detection of the position of the welding bead on the outer surfaces of welded metal pipes would improve any pipe making methods, since said position detection would allow the welding bead of a welded pipe to be properly processed, thereby enhancing the aesthetic and functional properties of said welded pipe.

This is, for example, true as the welding operations are performed on a concealed face of a furniture component, or in engagement holes for rods, screws and bolts, the welding bead could interfere with.

A further practical example is a welding of folding workpieces, since in such an application the welding bead negatively affect a proper operation and strength of the bent workpiece.

Prior detection methods, automatically detect the position of a welding bead on the outer surface of a welded pipe by optical detecting systems including an optical sensor which detects said welding bead position from brightness variations on the pipe surface, which generate contrast regions including a light band, corresponding to the welding bead, on a dark pipe, or vice versa.

It should be apparent that such an optical detection system would be very inefficient or “blind” for a pipe having an outer surface scratched or covered by dirt, fat, oil, rust or paint stains, or a pipe with poor optical characteristics of its material and weldment region.

Actually, in such a case, a prior optical system would either detect a low signal/noise ratio contrast or several signal brightness peaks, which cannot be so distinguished from one another as to allow to precisely detect the position of said welding bead.

### SUMMARY OF THE INVENTION

Accordingly, the aim of the present invention is to provide a method for cleaning pipes, in particular the outer surface of a metal tube, for removing therefrom elements hindering an optical read-out of the position of a welding bead.

A further object of the present invention is to provide a device for carrying out the above cleaning method.

The above objects are achieved by a method for cleaning the circumferential outer surface of a welded metal pipe, said method being characterized in that said surface is cleaned by melting, evaporating and/or sublimating extraneous materials or flaws on said surface.

Said objects are further achieved by the device for carrying out the above method, said device being characterized in that it comprises a laser beam source.

More specifically, the above and other objects are achieved by a cleaning method and device respectively according to claims 1 and 6.

Preferred embodiments of the invention are defined in the remaining subclaims.

Thus, by the cleaning method and device according to the invention, the outer surface of a welded tube is so processed and cleaned to provide a clear optical contrast between the material of the pipe and its welding bead, thereby allowing a position detecting system to precisely detect and locate the position of the pipe welding bead, to in turn allow an operator to accurately set a proper position for performing further processing operations on said welding bead.

### BRIEF DESCRIPTION OF THE DRAWINGS

The above mentioned objects, advantaged and features will become more apparent from the following disclosure of a preferred embodiment of the inventive cleaning method and device which are illustrated, by way of a non limitative example, in the accompanying drawings, where:

FIG. 1 is a schematic view showing an operating step for causing a laser beam to properly impinge on the outer surface of a pipe to be cleaned;

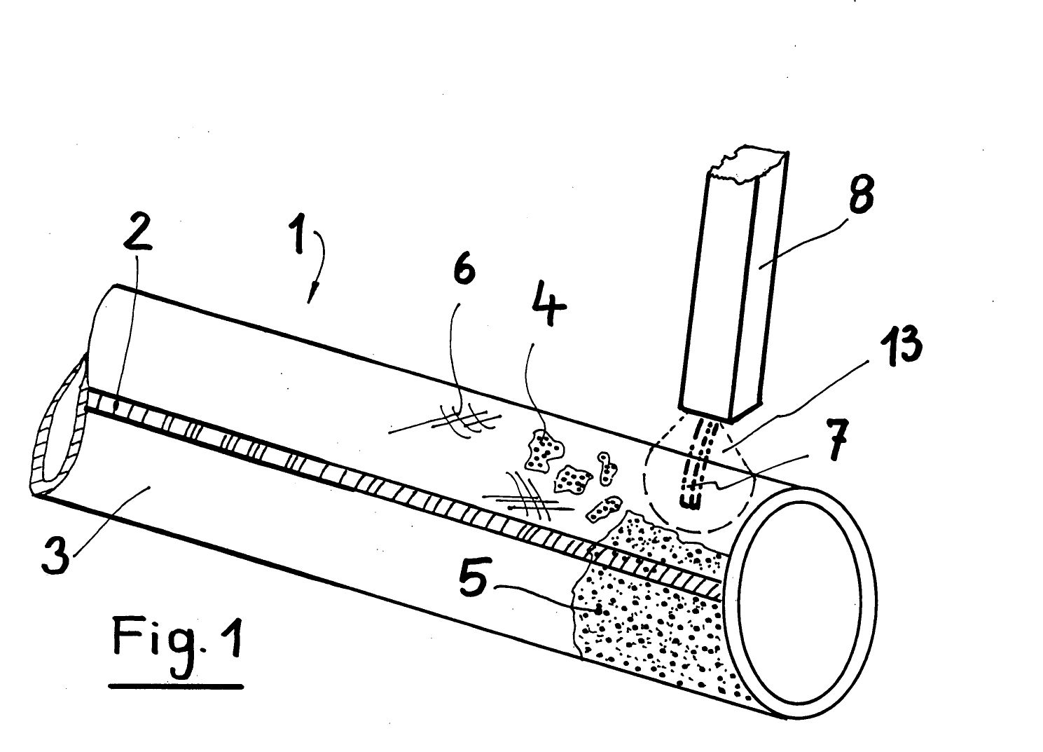

FIG. 2 is a further schematic view showing a cleaning operation being performed on the pipe of FIG. 1; and

FIG. 3 shows the cleaning result achieved according to the invention;

### DESCRIPTION OF THE PREFERRED EMBODIMENTS

The reference number 1 generally shows a pipe to be cleaned by a cleaning method according to the invention.

Said pipe is a metal pipe, and has been welded at a welding bead 2 on the pipe surface 3 which welding bead 2 is partially smeared or covered by oil, fat or rust stains 4, paint layers 5, scratches or notches 6.

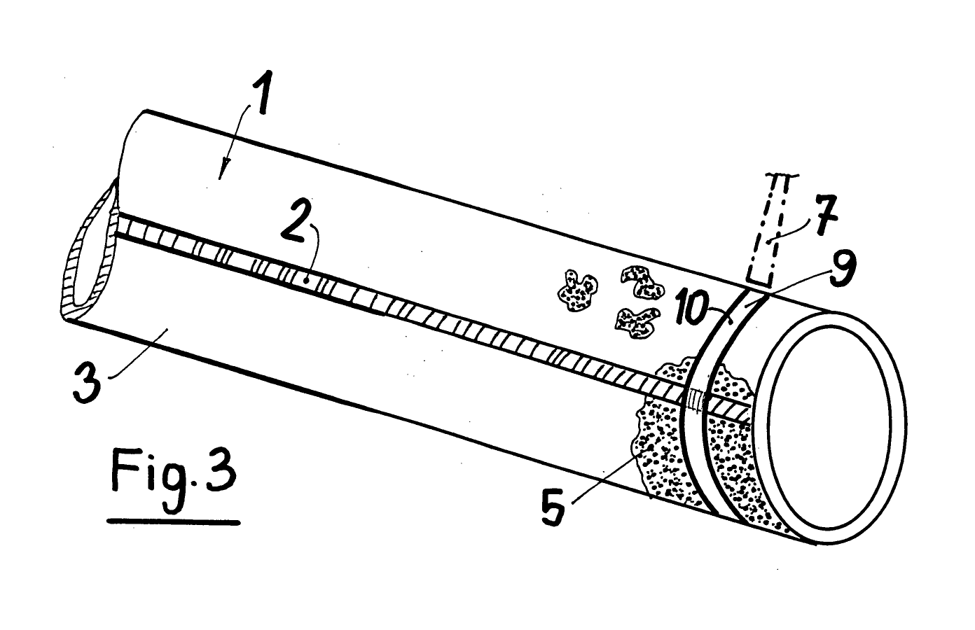

For eliminating the above flaws, which would hinder an optical detection for properly detecting the position of the welding bead 2 on the outer surface 3 of the pipe 1, the method according to the invention provides to cause a laser beam to impinge on said surface 3, said laser beam 7 being properly focalized on the surface 3 level. To that end, the laser beam 7 emitting head 8 is so arranged to cause said impinging laser beam to be only absorbed by the surface layers of said pipe 1, thereby allowing the laser impinging portion 9 of the surface 3 of the pipe 1 to be properly cleaned by melting, evaporating and/or sublimating the dirt, fat, oil and paint stains 4, 5, and scratches 6, the cleaning being achieved by melting, evaporating and/or sublimating the first surface layer 10 of said pipe 1 (FIG. 3).

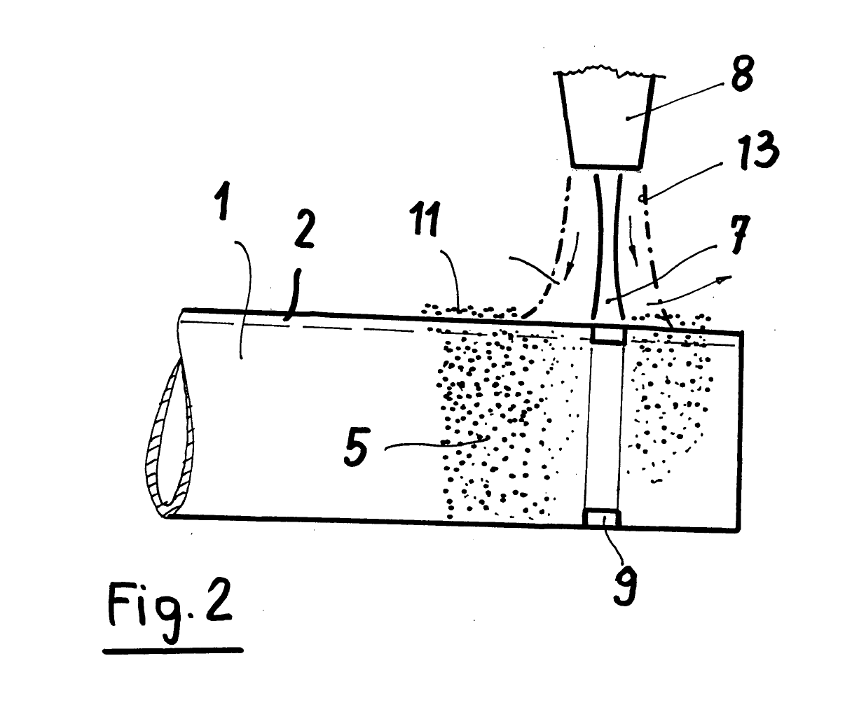

To easily remove the molten material 11 and vapors 12 from said surface portion 9 in addition to the laser beam 7, an aiding gas jet 13 (FIG. 2) is further caused to impinge on said portion 9, thereby forming on the surface 3 of the pipe 1 and easily detectable and identifiable optical contrast between said surface material and said welding bead 2 of said pipe 1.

The laser beam 7 emitting head 8 used in the inventive method and device may comprise, for example, a laser beam emitting system of a commercially available type, such as of a type made by the same Applicant.

The advantages of the method and device according to the invention can be easily deduced from the following example.

1-7. (canceled)

8. A method of cleaning a circumferential outer surface of a welded metal pipe, comprising the steps of: melting, evaporating and/or sublimating extraneous materials and flaws from said surface of said pipe.

9. The method according to claim 8, and focusing a laser beam at said surface.

10. The method according to claim 9, and impinging said laser beam on a circumferential portion of said surface thereby cleaning said circumferential portion by melting, evaporating and/or sublimating fat, oil and paint deposit forming materials and removing scratches from said surface by melting, evaporating and/or sublimating a first surface layer of said pipe.

11. The method according to claim 10, and impinging a jet of a removing gas on said circumferential portion to remove from said circumferential portion molten materials and vapors generated from the cleaning.

12. The method according to claim 9, wherein a laser beam source generates the laser beam.

13. An optical detecting method of optically detecting a position of a welding bead on an outer surface of a welded metal pipe, comprising the steps of cleaning a circumferential surface of said pipe by melting, evaporating and/or sublimating extraneous materials and flaws from said surface of said pipe.

14. A metal pipe welded by a welding bead, comprising: a pipe surface cleaned by melting, evaporating and/or sublimating extraneous materials and flaws from said surface of said pipe.
